(19) United States
(12) Patent Application Publication
(10) Pub. No.: US 2006/0095375 A1
(43) Pub. Date: May 4, 2006

(54) Method for the standardization and syndication of business transactions

(76) Inventors: Robert E. Doyle, Paramus, NJ (US); Herbert Gandel, Little Silver, NJ (US)

Correspondence Address: Anthony Pantaleoni;FULBRIGHT & JAWORSKI L.L.P., 666 Fifth Avenue, New York, NY, 10103, US

(21) Appl. No.: 11/303,606

(22) Filed: Dec. 16, 2005

Related U.S. Application Data
(62) Division of application No. 10/411,020, filed on Apr. 9, 2003.
(60) Provisional application No. 60/371,292, filed on Apr. 9, 2002.

(51) Int. Cl. G06Q 40/00; G06F 7/00; G06F 17/00

(52) U.S. Cl. 705/44; 707/100

(57) ABSTRACT

A method for standardizing and syndicating international business transactions over a communications network, comprising the steps of receiving a transactional request containing terms of the business transaction from a client and categorizing the transaction into pre-defined categories. The method retrieves the functional templates for the pre-defined categories from a database and generates functional aspects of the business transaction, such as forms, documents and the like, based on the terms of the business transaction and client information to enable the client to execute the business transaction.

### RELATED APPLICATION

This application is a divisional application of Ser. No. 10/411,020 filed Apr. 9, 2003, which is a continuation of pending U.S. provisional patent application Ser. No. 60/371,292 filed on Apr. 9, 2002, which are incorporated by reference in their entirety herein.

### BACKGROUND OF THE INVENTION

As the world's economies have merged into one global economy, cross border trade has gained in importance and frequency. These cross border transactions range from a simple sale of goods to complex construction projects and more. Individuals in the United States want to sell food to African corporations. French communications firms want to contract with governments in less developed countries to set up their communications infrastructure. German construction companies want to bid on an airport construction project in South America. Canadian investors want to finance a business in Indonesia. Businesses all over the world are identifying business opportunities outside of their national borders.

While economies all over the world have opened themselves to the idea of globalization, the cost of cross border transactions, in terms of money, time, and effort, has remained a barrier. Although many businesses have identified opportunities outside of their borders, they have little knowledge of the requirements for executing a cross border transaction. It may be impractical for these businesses to invest resources into understanding a specific cross border transaction, when the change of one variable, such as the country of origin of the goods or the type of goods, may call for a completely different process. Even when a business identifies an opportunity that requires the execution of the exact same transaction every time, the transaction may still prove to be too costly. Such transactions can require as many as 200 documents to complete one deal. It can take six months or longer to process paperwork. Legal and other procedural costs have averaged seven percent of a transaction's value, as high as fifteen percent. Businesses of all sizes have held back from entering a growing and lucrative global marketplace because of the awesome paperwork load, its expense and incalculable variable costs. In order to maximize trade efficiencies on a global scale, the overhead costs of cross border transactions must be reduced to a practical level.

Others before have attempted to implement electronic solutions to reduce the high overhead costs of international transactions. While many of the systems implemented are excellent task performers, they lack the flexibility and interoperability to handle the expansive range of international transactions. These systems are typically designed to handle a specific transaction for a large Fortune 1000 company, but because these products are proprietary, conflicting application standards prevents cost effective seamless interoperability among enterprises. The expense and inefficiency of constant system updating and reengineering in order to interface with multiple information technology systems in the execution of one desired transaction does not equate to the desired comprehensive solution to reduce overhead costs across all cross border transactions.

### OBJECTS AND SUMMARY OF THE INVENTION

The present invention overcomes the prohibitive overhead costs of international business transactions by providing a systemic approach to all business transactions, whether across international borders or across the street. It overcomes the problems associated with the transfer of information by communicating through a standardized universal language over an open architecture. It overcomes the problems associated with delay through the dynamic acquisition and storage of relevant information and documentation along with the simultaneous execution of required actions. It defines a business method for the efficient execution of any business transaction, as well as a system that implements that method. In effect, it provides businesses all over the world, regardless of their size, with a tool to efficiently and seamlessly conduct business transactions by simply specifying the goals of their desired transaction.

It is an object of the present invention to provide a method for standardizing and syndicating international business transactions over a communications network, comprising the steps of receiving a transactional request containing terms of the business transaction from a client and categorizing the transaction into pre-defined categories. The method retrieves the functional templates for the pre-defined categories from a database and generates functional aspects of the business transaction, such as forms, documents and the like, based on the terms of the business transaction and client information to enable the client to execute the business transaction.

In accordance with an embodiment of the present invention, the system dynamically collects and stores information, forms, documents, etc. relevant to the conduct of the nearly infinite range of known transactions in a central repository, or various repositories. The system may acquire such information from strategic partnerships with entities such as world trade organizations, national government agencies, local government agencies, private companies dedicated to the acquisition of such information, etc. The system may also acquire such information from publicly available sources, including databases connected through communications networks.

In an embodiment of the present invention, the system links the acquired information according to a certain transaction grouping. For example, after acquiring the required construction permits for building a road in Brazil, the system can store such permits under one or more groupings, such as, Brazilian Road Construction, Brazilian Project, Road Projects, etc. The system can link such information under one or more transactional groupings in any manner known in the art of data storage and indexing.

According to an embodiment of the present invention, the system constantly updates the stored information, forms, documents, etc. to ensure that such information is not outdated. The system can update this information automatically through scheduled updates or triggers or any other fashion. The system can also invoke manual updates in response to specific requests or as a system check or for any other purpose. Furthermore, the system operator or administrator can partner with a governmental organization, a private company or other entities to ensure the “freshness” of the information in the system, such as new governmental regulations or new rate structures, etc.

In an embodiment of the present invention, the system solicits transaction parameters from a user and identifies, from its repository (or repositories), a specific transaction or transactions consistent with those parameters. Once the system ensures that the correct transaction(s) has (have) been identified, the system can develop a transaction template, which guides the execution of the identified transaction(s), and then display it to the user. The template can comprise the following illustrative list of features or any combination thereof: a list of the required steps to execute the desired transaction(s); a list of the documents that need to be completed to execute the transaction(s); instruction on how to acquire and/or complete those documents; links to electronic versions of such documents; links to submit those documents to the proper authorities; a list of governmental approvals required; contact information (such as phone number, e-mail, fax number, etc.) for the appropriate authorities who provide such approvals; guidelines for acquiring such approvals; electronic applications for such approvals; lists of buyers for goods; lists of sellers of goods; contact information for such buyers or sellers; platforms for electronically negotiating prices and quantities between the buyers and sellers; lists of shipping companies that pick up and deliver such goods, from and to such locations; electronic reservation and payment form for such shipping companies; lists of banks/investors that fund such transactions; etc.

In an embodiment of the present invention, the system utilizes open standards in its system architecture to enable the system to acquire data from its data sources and deliver information to trading partners. This open standards-compliant hub architecture overrides incompatible application platforms and enables coherent message and document transmission between trading partners. Open proficiency effects process integration with back-end operating systems. Companies or countries engaging in electronic cross border trade may agree to communication and information specifications for transaction protocols. These protocols become the guidelines for processing electronic commerce within the hub. Trading partners do not need a common set of hardware, operating systems, middle-ware, or application software, nor must they be aware of their counterpart's IT competence in order to do business with one another. Trading partners may control and guide the business process, which is isolated from the technology process, and are solely responsible for confirmation or cancellation of a result.

In a preferred embodiment of the invention, there are two categories of protocol, one for the business process, the second for the technology process, both protocols being harmonized within the hub. Business process protocols may be organized into partner-specific modules constructed by congregating data templates delineating a trading partner's IT capabilities and, for a company, identification data (ISO, NAICS, ANSI, SITC codes, etc.), industry role (i.e., producer, service provider, distributor, location(s), business history, management), local laws, national treaties and agreements relevant to cross border trade, etc. For a country, a module may encapsulate geography, population, government, economy, literacy, languages, computer literacy, suffrage, labor force, treaty, pact and trade bloc signatories, basic industries, natural resources, trade partners, communications, transportation and defense forces. The technology process protocol applies open source XML language to translate business process input and synchronize multiple platforms into standards-consistent messages, documents or other acknowledgments. ISO 15022 principles make possible the conversion of any message or document type to support specific information flows. Outcomes are governed by the precepts of the business process, not by a central design authority, and a durable record of decisions is compiled to allow consideration of numerous possible successful outcomes, such as various what if outcomes.

In an embodiment of the present invention, the system utilizes known or proprietary encrypted technology to provide secured communication between various parties to the transaction. For example, when instructed by a trading partner, the system can encrypt resulting documents to provide secured documents that are accessible only by the trading partners or their agents. Each trading partner's process implementations can be kept independently, and trade transaction complexity may be embedded and automated within the system's hardware and software infrastructure. Furthermore, intuitive computing can restate results in the originating language such as English, French, German, Russian, Japanese, various dialects of Chinese, etc., of each trading partner enabling real-time interaction and informed decisions.

It is an object of the present invention to provide a system and technique for more efficiently conducting international trade.

It is also an object of the present invention to provide a system and technique for syndicating international trade.

It is another object of the present invention to provide a system and technique that simply, efficiently, and effectively guides businesses and individuals through complex transactions, whether within a nation's border or across international borders.

It is yet another object of the present invention to provide a system and technique that simultaneously executes the various tasks involved in a complex transaction, whether within a nation's border or across international borders.

It is still another object of the present invention to provide a system and technique that utilizes open standards in its system architecture so that the various systems of the parties involved in a transaction may effectively communicate with one another absent the barrier of reconfiguring their systems for the sake of compatibility

It is a further object of the present invention to provide a system and technique that effectively centralizes the resources needed to complete complex transactions, whether within a nation's border or across international borders.

It is yet a further object of the present invention to provide a system and technique that indexes and stores the information collected regarding a specific transaction in such a manner that future users may easily and efficiently reuse such information in the completion of identical or similar transactions, or transactions which involve identical or similar steps in their completion.

Various other objects, advantages and features of the present invention will become readily apparent from the ensuing detailed description, and the novel features will be particularly pointed out in the appended claims.

### BRIEF DESCRIPTION OF THE DRAWINGS

The following detailed description, given by way of example, and not intended to limit the present invention solely thereto, will best be understood in conjunction with the accompanying drawings in which:

FIG. 1 is a block diagram of the system architecture of an embodiment of the present invention; and

FIG. 2 is a flow chart for the system process of an embodiment of the present invention; and

FIG. 3 is a block diagram illustrating a logical view of the system architecture of FIG. 1; and

FIG. 4 is a flow chart illustrating the data flow in accordance with an embodiment of the present invention; and

FIG. 5 is a flow chart for processing a request for information in accordance with an embodiment of the present invention; and

FIG. 6 is a flow chart for processing a request for business transaction in accordance with an embodiment of the present invention.

### DETAILED DESCRIPTION OF THE EMBODIMENTS

Currently available communications apparatus and electronic components readily implement the present invention. The invention finds ready application in virtually all-commercial communications networks, including, but not limited to, an intranet, a local area network (LAN), a wide area network (WAN), World Wide Web, a telephone network, a wireless network, and a wired cable transmission system.

The present invention avoids the weaknesses of current systems by facilitating the execution of complex transactions, including international transactions, by utilizing open standards in its system architecture and allowing compatibility between the systems of all parties involved in such transactions. Additionally, the present invention provides the benefit of flexibility, as it has not been tailored for the transactional needs of any particular business or industry. The system of the present invention is dynamic and systematically and comprehensively collects the required information and resources required to guide the execution of and/or execute transactions as requested by its users. The system also stores and indexes the information collected for requested transactions in such a manner that it allows for syndication of one or more components of those transactions.

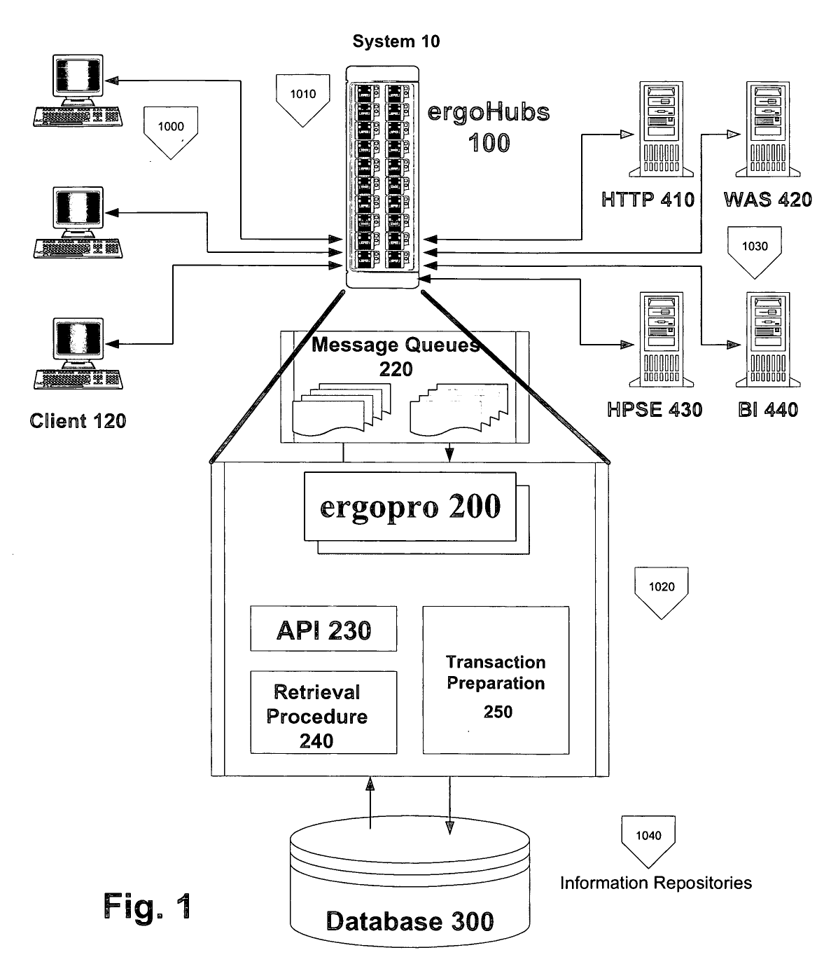

Turning now to FIG. 1, the block diagram illustrates an ergomundus system 10 (or system 10) in accordance with an embodiment of the present invention. According to this embodiment of the present invention, clients 120 initiate the transaction by contacting the system hub or ergohub 100. The hub 100 solicits information from such clients 120, including, but not limited to, transaction parameters and client or user profile information. The hub 100 processes such solicited information and compares the solicited transaction parameters to transaction parameters that have been previously categorized, indexed, and stored in the system repository or database 300. It is appreciated that within the system repository, data warehouse or database 300, transaction parameters may be connected to align specific cross border transactions or parts thereof either automatically by the system hub 100 or through manual labor.

In accordance with an embodiment of the present invention, the business transactions are based on template, profile and informational need of each client. The business transactions are predefined and coded for each client. There is a single modular transaction for each subtask associated with the completion of a particular business transaction. Client profiles provide client specific information based on pre-negotiated terms and conditions, such as security issues, customer base, country preference etc. Templates are internal ergopro instructions to locate the required information or instruction to complete the requested transaction. Ergopro 200 is a software application residing in the ergohub 100, which utilizes ergodna or ergomundus dynamic navigational architecture. Ergopro 200 formulates, personalizes, secures, stores, information locates, places in a ‘folder’ and executes to a predefined state of completion of the business transaction. Foldering is the process whereby data from many different sources is collected and stored in one location within the ergopro application.

The system 10 maintains a data warehouse 300 for all information and process within a secure environment. The data repository or data warehouse 300 contains information such as forms, laws, logistics, transportation information, trade agreements, export procedures, maps, tax instructions, etc.

The process of initiating a business transaction using the ergomundus system 10 in accordance with an embodiment of the present invention is now described in conjunction with FIG. 1. The client 120 submits a client request to the ergomundus system 10 via a communications network, such as telephone network, cable network, local area network, Internet, etc., using a standard web browser or graphic user interface (GUI) in step 1000. The ergomundus system 10 routes the client request to the appropriate ergohub 100 in step 1010. It is appreciated that the ergohub 100 can be a single machine (or computer) or a collection of machines. The ergohub 100 executes specific functions to determine requirements, location, client rights, client profiles, etc. In accordance with an embodiment of the present invention, the ergomundus system 10 determines a particular ergohub 100 and/or configuration of the ergohub 100 based on the geographical and functional requirements of the client's business transaction.

The ergopro 200 initiates transaction preparation module 250 to assign entitlements and prepare the business transaction, such as legal issues, whether the contemplated business transaction is allowed in the selected country, countries and companies included in the business transaction, etc., in step 1020. Also, the ergopro 200 sets up retrieval procedures 240 to retrieve information from the internal database 300 or to interface with external systems through application protocol interface (API) 230, preferably an open architecture interface, in step 1030. In many cases, the information required to transact business through the ergomundus system 10 has been already collected and stored in the business intelligent warehouse database 300. In accordance with an embodiment of the present invention, if the requisite information is available from the system database 300, then ergopro 200 sets up background processes in step 1030, such as high speed search engine (HPSE) 430 and business intelligent (BI) process 440, to search and retrieve the information from various information repositories of the system database 300 in step 1040. The system database 300 contains various information repositories to hold legal information, logistics information, client information, etc.

However, if the requisite information is unavailable from the system database 300, then ergopro 200 sets up background processes, such as API 230, to interface with an external system (e.g., governmental databases), or hyper text transfer protocol (HTTP) process 410 or web application server (WAS) process 420 to access the Internet in step 1030.

For example, the system database 300 may contain information on the construction of an airport in Beirut. One step of this construction project may have been the bidding process to obtain the Lebanese Government contract for the construction of the airport. If bidding for government contracts in Lebanon had been previously conducted through this system 10, then the hub 100 has already stored the required documents, contacts, fees, process steps, etc., that were needed to correctly execute the bidding process for government contracts in Lebanon. Also, the hub 100 has already categorized and indexed this information accordingly within the system 10. In another embodiment, a system administrator or operator manually enters, categorizes, and indexes the bidding information into the system 10 after researching that information. In still another embodiment, the hub 100 may continuously or periodically research databases around the world for the bidding information. In yet another embodiment, the system 10 operators or administrators partner with governments and/or private firms around the world to collect such transaction information for the system 10. In other embodiments of the present invention, the methods mentioned above, in addition to countless others could be used to update the system databases 300 with the required transactional information for a variety of transactions and parts thereof.

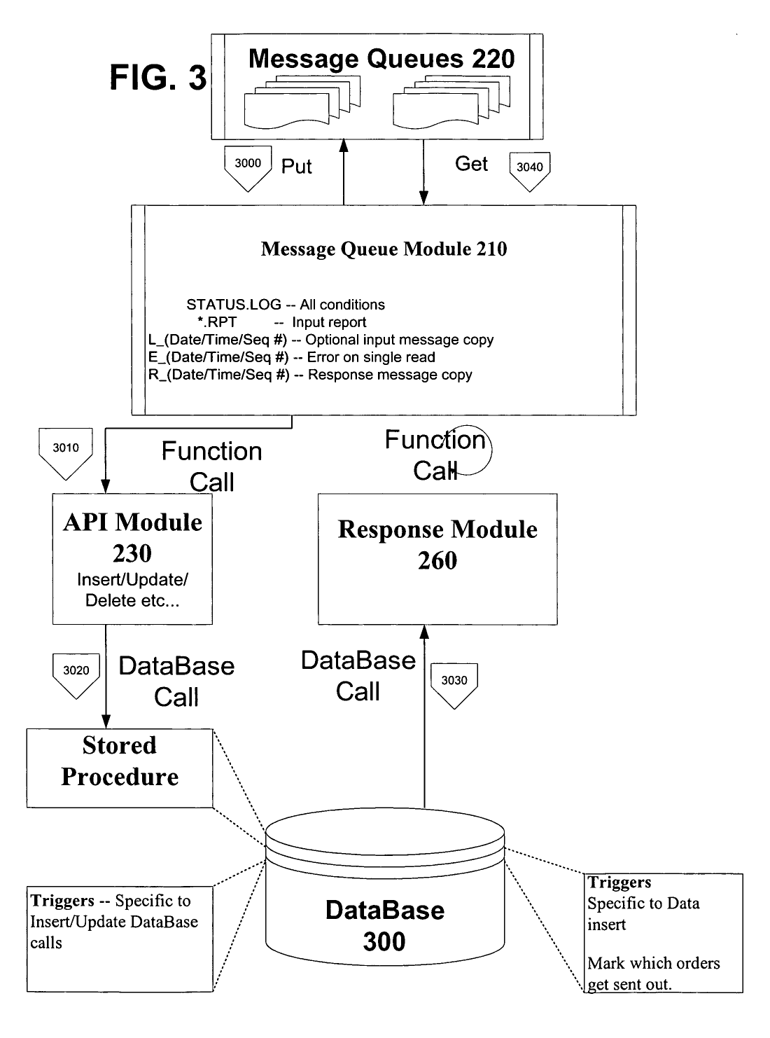

In an embodiment of the present invention as illustrated in FIG. 1, based on the transactional information already stored in the system database 300, the hub 100 generates functional transaction templates for each transaction category or sub-category. These functional templates include but are not limited to templates for generating business documents, templates for collecting the relevant contact information, templates for calculating fees associated with the transaction, templates for generating electronic links to sources of further information, templates for generating flow charts of the optimal steps required in completing the transaction or certain steps of the transactions, templates for generating communication links with parties to the transaction, etc. In the Beirut airport example, based on the bidding information previously collected, categorized, indexed, and stored in the system database 300, the hub 100 may have generated document templates for all the forms that must be completed and submitted to the Lebanese government in order for a bid to be considered; fee templates for all the fees that must be submitted to the Lebanese government, the form of such fees, and the payees to which such fees may be address; contact templates with listings of government officials to be contacted for specified reasons and hyper-text links to their email addresses. In accordance with an aspect of the present invention, FIGS. 3-6 show an implementation of the inventive system of FIG. 1.

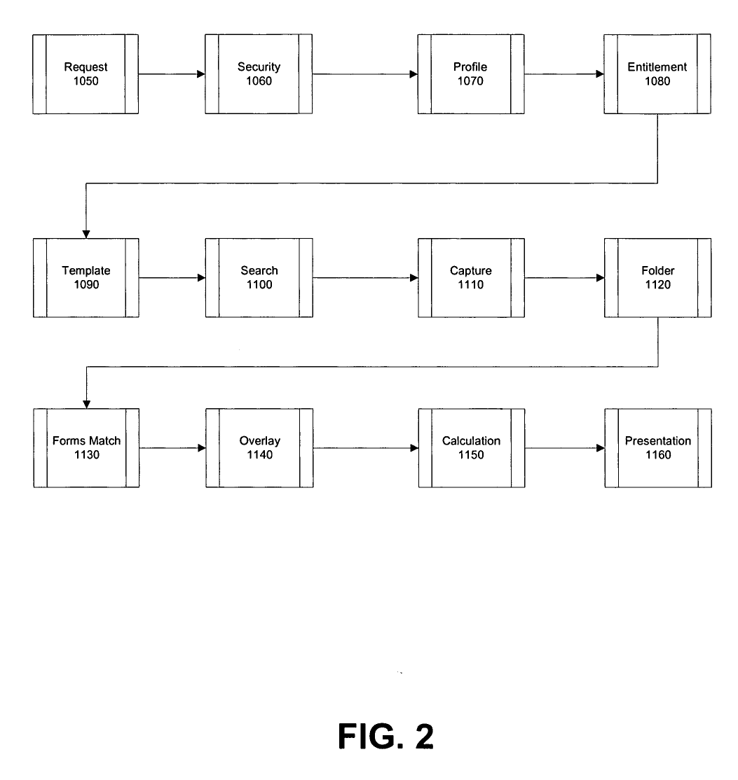

In an embodiment of the present invention as illustrated in FIGS. 2, 5, and 6, the hub 100 houses the transaction parameters solicited from the client to search for pre-categorized transaction parameters stored and indexed in the system database 300. If the hub locates matching transaction parameters, then the hub 100 accesses the functional templates stored in connection with such transaction parameters and retrieves such functional templates for the client's use. In an embodiment of the present invention as illustrated in FIG. 2, the hub 100 can collect matching templates in a single folder as it processes its search for all templates that may be connected to the specified transaction or steps thereof. In another embodiment of the present invention the system 10 may collect the functional templates identified via the solicited transaction parameters in different folders labeled according to a specific part of the transaction. In still another embodiment of the present invention, the hub 100 may collect such functional templates in a single folder with subfolders identifying templates with specific portions of the transactions. In other embodiments of the present invention the methods identified above for the collection and retrieval of the functional templates in addition to countless others may be used by the hub 100 to access and retrieve the functional templates for a specific transaction. For example, if a user is interested in building an electric plant in Beirut, and the bidding process for Lebanese Government contracts with related functional templates have been categorized, indexed, and stored in the system database 300, then the hub 100 may collect the Lebanon Government Contract Bidding templates in a folder labeled as Lebanon Government Contract Bidding as it searches for other templates associated with the building of an electric plant in Lebanon.

An exemplary manner in which the ergomundus system 10 processes a business transaction in accordance with an embodiment of the present invention is now described in conjunction with FIG. 2. The client 120 accesses the ergomundus homepage via the Internet and requests access to the ergomundus system 10 in step 1050. For example, the client may enter userid, password, and other information to access the ergomundus system 10. In accordance with an embodiment of the present invention, the information is entered on a pre-designed screen based on the transaction type and entitlements. The ergopro 200 verifies or performs security checks based on the userid and password in step 1060. In accordance with an embodiment of the present invention, the ergopro 200 may request the client 120 to answer additional questions as part of the security check in step 1060. Alternatively, various other security measures can be utilized, which can be chosen by the client. Once the client 120 has been verified as an authorized user, ergopro 200 provides the client 120 with an access to the ergomundus transaction homepage.

The ergopro 200 inserts a predefined client profile from the ergo or system database 300 in a dynamic data folder, which may comprise multiple sub-folders, to control compatibility with ensuing transactional insertions, as described herein, in step 1070. For example, the client profile may contain various client specific information based on pre-determined parameters established between system provider (e.g., ergomundus) and the client, such as legal information, trade agreements, client contractual agreements, permitted transactions, countries, transaction types, such as business to business, procurement, business to government, etc.

The ergopro 200 inserts an entitlement guide to specific international trade information based on client predetermined trade agreements and legal information in the dynamic data folder in step 1080, and business transaction navigational templates negotiated with various trading partner and defined based on client contractual agreements in step 1090. After various client specific information are obtained, the ergopro 200 instructs one or more background processes, such as HTTP 410, WAS 420, HPSE 430 and BI 440 to search the system database 300, Internet, and external systems based on the client information collected in the dynamic data folder in step 1110. It is appreciated that the background processes can use any known searching techniques, such as web crawling. The results of the searches are captured and stored in the system database 300 for use by the ergopro 200 in step 1110.

The ergopro 200 also files and organizes the results that was captured and stored in the system database 300 in the dynamic data folder, such as in dynamic transaction sub-folder, in step 1120. Also, the ergopro 200 indexes the results based on the information type and associates the information to a specific client request in step 1120.

After indexing the information, the ergopro 200 retrieves all necessary forms to complete the business transaction specified in the client request are obtained either from the system database 300 or from external systems, e.g. governmental forms from appropriate government agency, and inserted into the dynamic folder in step 1130. The ergopro 200 completes the form (or provides form fulfillment information) using the search results and the client information in the dynamic data folder in step 1140. Also, in step 1140, ergopro 200 verifies that information are consistently provided in various forms, sorts and sequences the forms in appropriate order, and identifies the forms using tags or fields in the dynamic data folder. In accordance with an embodiment of the present invention, the ergopro 200 forwards any calculations and/or estimations required to complete the forms to the client 120 for review and enters such calculations and/or estimations only after receiving approval and instructions (or requests) to make such entries from the client 120 in step 1150.

After ergopro 200 determines that all requisite forms have been completed and requisite transactional information have been collected, ergopro 200 organizes these forms and information into a presentation format suitable for display to the client 120 in step 1160

According to an embodiment of the present invention as illustrated in FIG. 1, if the hub 100 fails to locate functional templates associated with some or all of the transaction parameters, then the hub 100 searches for the information required to complete this transaction beyond the system boundaries. The hub 100 may search databases outside of the system through various communications networks, including, but not limited to, an intranet, a local area network (LAN), a wide area network (WAN), World Wide Web, a telephone network, a wireless network, and a wired cable transmission system. In another embodiment of the present invention, a system administrator would manually acquire the information required to complete the transaction and then manually enter the information into the system 10 so the hub 100 could generate the required functional templates. In still another embodiment of the present invention, the system 10 administrators could partner with a private research firm to acquire and enter the information on demand. In yet another embodiment of the present invention, the hub 100 simply provides the client 120 with templates already stored within the system database and any parts of the transaction that are unaccounted for must be completed by the client absent the guidance of the present invention. In even another embodiment of the invention, if the database 300 does not contain a template to account for a part or all of a client's requested transaction, the hub 100 provides the client 120 with templates that are most similar in nature and characteristics for guidance in completion of the transaction. Other embodiments of the present invention may include a combination of any or all of the above-mentioned information retrieval processes in addition to countless others.

According to an embodiment of the invention as illustrated in FIG. 1, when the hub 100 retrieves information from outside the system, the hub generates functional templates based on such information. In addition to providing these templates to the client 120 in a system folder or system folders, the hub 100 also categorizes the functional templates according to the specific transaction or part thereof and stores the templates in its database 300 for future use. Continuing with the Beirut power plant example, if the only functional templates contained within the system 10 for this particular transaction are the ones relating to the bidding portion of the transaction, then the hub will reach out to databases of the Lebanese government over the World Wide Web and access the required information for the remaining portions of the transaction. The hub 100 has security clearance with respect to these databases through a partnership with the Lebanese government. In an embodiment of the present invention, the hub 100 will be able to access the databases on the Lebanese government's systems because the system of the invention uses an open system architecture, which freely allows electronic data exchange and messaging throughout the world.

In accordance with an embodiment of the present invention, the system 10 utilizes open standards in its system architecture to enable the system 10 to acquire data from its data sources and deliver information to trading partners. This open standards-compliant hub architecture overrides incompatible application platforms and enables coherent message and document transmission between trading partners. Open proficiency effects process integration with back-end operating systems. Companies or countries engaging in electronic cross border trade may agree to communication and information specifications for transaction protocols. These protocols become the guidelines for processing electronic commerce within the hub. Trading partners do not need a common set of hardware, operating systems, middle-ware, or application software, nor must they be aware of their counterpart's IT competence in order to do business with one another. Trading partners may control and guide the business process, which is isolated from the technology process, and are solely responsible for confirmation or cancellation of a result.

According to an embodiment of the present invention as illustrated in FIG. 2, the hub 100 delivers a folder or folders containing the functional templates required to complete the specified cross border transaction. The hub 100 may use these templates in combination with the information solicited from the client 120 to generate the functional aspects of the transaction including, but not limited to, business documents, contact sheets, information links, communication channels, lists of fees, document submissions, fund deliveries, shipping instructions, etc. In another embodiment of the present invention, the hub 100 may simply deliver the folder or folders of functional templates to the client 120 without generating the functional aspects of the transaction. In still another embodiment of the present invention, the hub 100 may generate one or more of the functional aspects of the transaction while providing the client 120 with the templates for other aspects of the transaction. In yet another embodiment of the present invention, the hub 100 may generate one or more of the functional aspects of the transaction, provide templates guiding one or more other aspects of the transaction, and provide no guidance for the remaining aspects of the transaction. In the context of the Beirut power plant example, the hub 100 may generate all of the business documents with respect to the bidding portion of the transaction, submit those bidding documents electronically to the Lebanese government, and transfer funds from the client's account to the appropriate Lebanese government accounts in satisfaction of the fees. Furthermore it may provide templates for ordering supplies from sources all over the world, templates for arranging communication links with authorities in the Lebanese government to discuss the status of the bid, templates for preparing the financial arrangements to finance the project in case the client 120 wins the bid, etc. Meanwhile other aspects of this complex transaction may be left to the user to complete without guidance.

Turning now to FIG. 3, there is illustrated a logical view of the system architecture in accordance with an embodiment of the present invention. The message queue module 210 of the ergopro 200 sends and receives information from other components of the system 10 via the message queue 220, which is uniquely assigned to each business transaction. It is appreciated that any known message queuing techniques and products can be utilized, such as IBM MQSeries® messaging product. Each server, background processes and applications supporting a particular business transaction can communicate with the ergopro 200 via a unique message queue (MQueue) 110 established for or assigned to that business transaction. The ergopro 200 communicates with each server, such as database 330, HPPT 410, WAS 420, HPSE 430 and BI 440, via a unique API module 230. For example, if the ergopro 200 wants to transmit a function call, e.g., a stored procedure for updating the database, to the system database 300 for a particular transaction, then the message queue module 210 formulates the request and places or puts the requested function call in the message queue 220 associated with that transaction (or the requesting message queue 220) in step 3000. The message queue module 210 delivers the requested function call in the requesting message queue 220 to the API module 230 of the system database 300 in step 3010. The API module 130 then sends the database call to the system database 300 and a matching set of stored procedures completes the necessary database task, such as updating the database, in step 3020. It is appreciated that certain information in the database 300 can be linked or related, such that any changes to a particular information may require its related information to change accordingly. For example, if the Chinese government changes its currency regulations, this may impact not only information regarding Chinese law, but may also impact procurement information, financing information, etc., for any Chinese related transaction. Accordingly, database triggers can be used to initiate new/changed requirements for all appropriate tables in the database 300 and to initiate changes to the result presentation.

The looping response module 260 of the message queue module 210 monitors the requesting message queue 220 to determine if the request is completed (i.e., a successfully completed message or an error message) in step 3030. If the looping response module 260 determines that there is a message in the requesting message queue, then the message is retrieved from the requesting message queue 220 by the message queue module 210 of the ergopro 200 in step 3040.

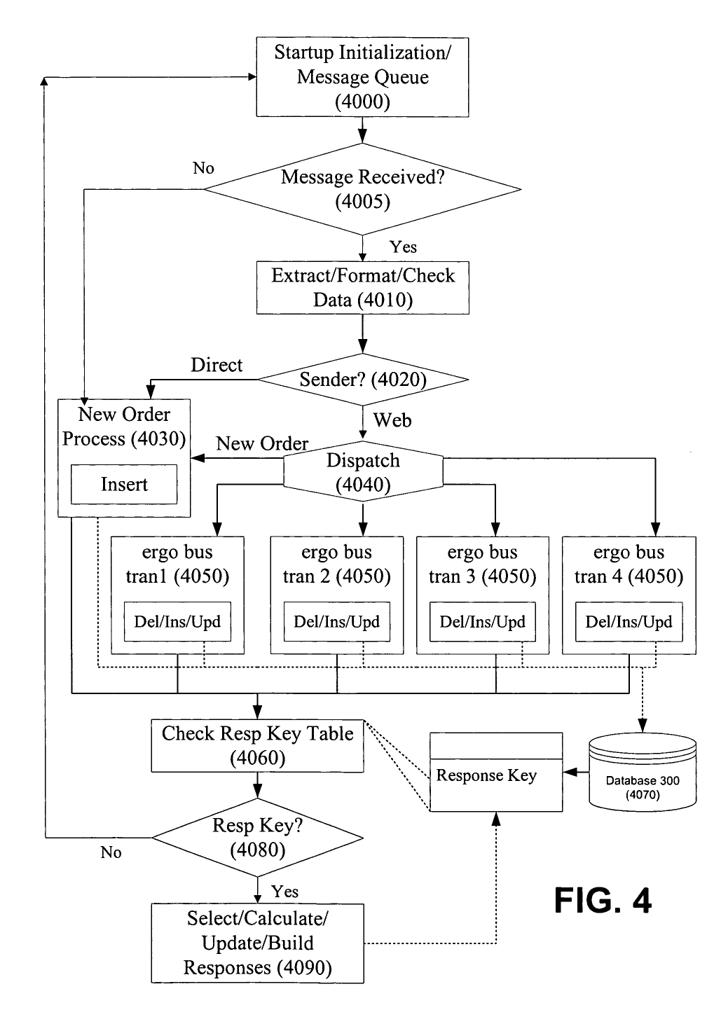

Turning now to FIG. 4, there is illustrated a data flow chart in accordance with an embodiment of the present invention. The message queue module 210 of the ergopro 200 initiates the message queue 220 in step 4000 and determines if there is a message in the message queue 220 in step 4005. If it is determined that there is no message in the message queue 210, then ergopro 200 proceed to step 4030 to process new order, i.e., building new business transactions for the clients. However, if it determined that there is a message in the message queue 220, then the ergopro 200 extracts and checks the information or data contained in the message in step 4010. Also, the ergopro 200 may reformat the data, if necessary, based on the record type. For example, data obtained from the Internet or an external system may need to be reformatted into the data standard of the ergomundus system 10.

After the data in the message has been confirmed, the ergopro 200 determines source of the message to associate the information to a pending business transaction process or folder or to create new business transaction process in step 4020. After the source of message or send has been identified, the ergopro 200 associates the message to the appropriate pending business transaction or creates new order process in steps 4030 and 4040. If the message is determined to be from the Web, such as a new request from client 120 or information from the Internet or external system, then ergopro 200 proceeds to step 4040 to dispatch the message and the information contained therein to the appropriate pending business transaction or create new business transaction for new client based on the client profile and template designation information. Otherwise, if the message is determined to be from the ergomundus system 10 (i.e., direct request), such a message containing an update function, funds transfer, etc., the ergopro proceed to step 4030 to setup a new order or background process to complete the task.

After dispatching the request/message to the appropriate business transaction or creating new transaction based on the client profile and template designation obtained from the system database 300, the ergopro 200 formulates a response to the request/message in step 4060 and stores the request/message in the system database 300 in step 4070. The ergopro 200 determines if the database 300 has all the necessary data and information (i.e., response key flag is “on” or response key is available in the response key table) to build a response in step 4080. The response key table is stored in the system database 300. If it is determined that the response key is available for this particular request, then ergopro 200 formulates the response in step 4090. However, if it is determined that the response key is unavailable for that particular request, then the ergopro 200 returns to step 4000 to add the message back in the appropriate message queue base on the request type.

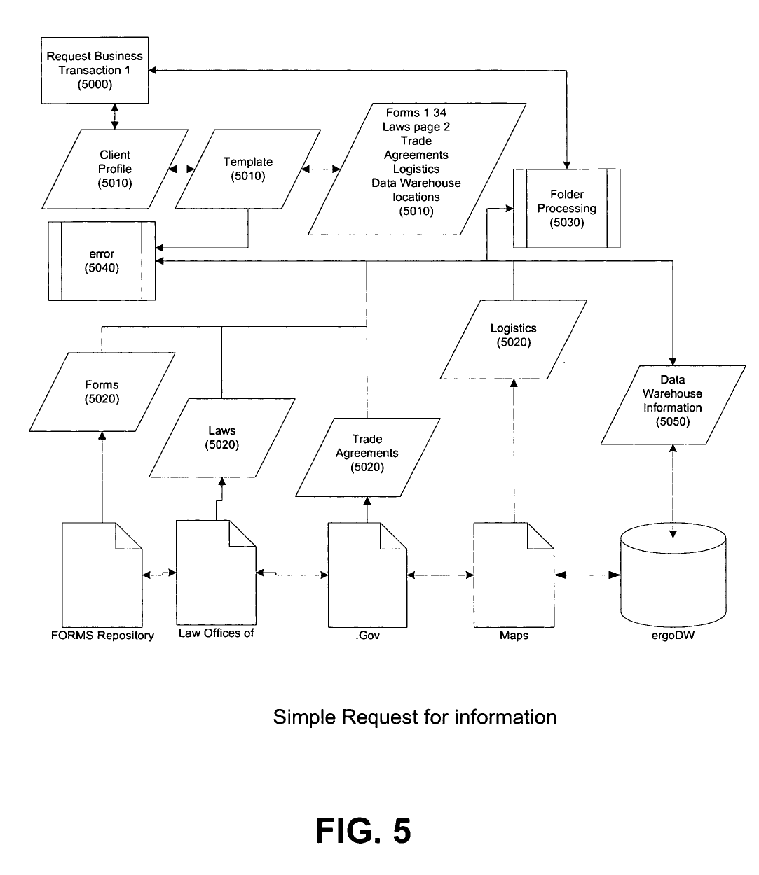

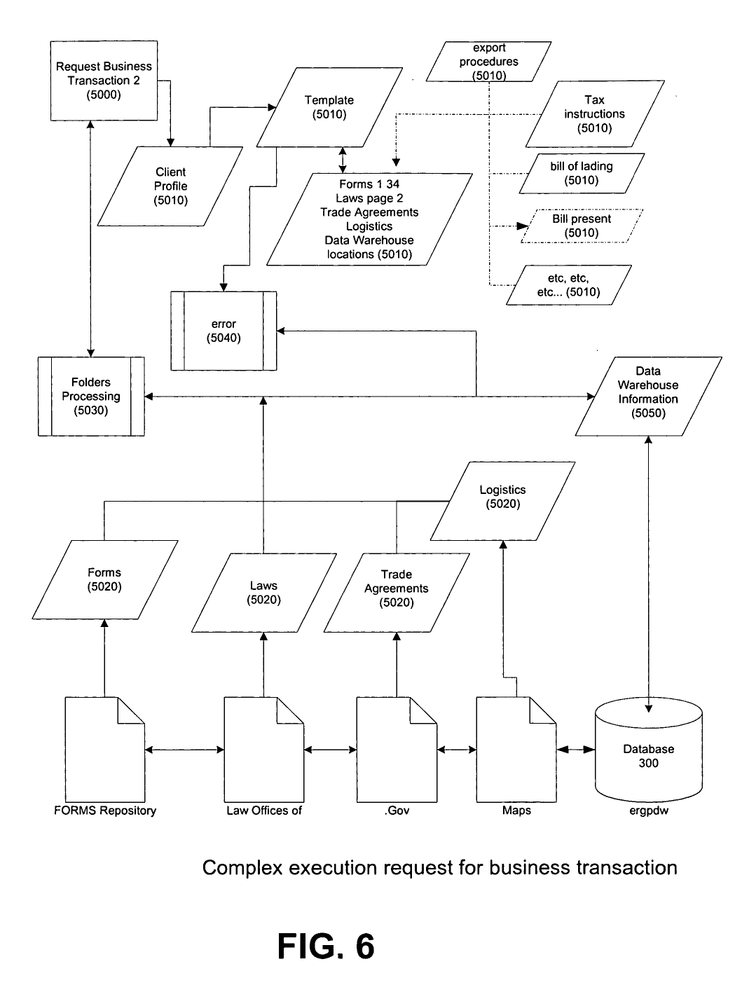

Turning now to FIGS. 5 and 6, there is illustrated a flow chart for processing an exemplary “simple” request for information and an exemplary “complex” request for business transaction execution, respectively, (i.e., types of business transaction) by the ergomundus system 10 in accordance with an embodiment of the present invention. The client 120 requests a business transaction (i.e., a request for information) in step 5000. Based on the client profile, template and required forms and documents, ergopro 200 begins the process of creating a dynamic folder and search criteria in step 5010. The ergopro 200 captures and compiles the appropriate forms, documents and information, such as export procedures, tax instructions, bill of lading, bill presentment, calculations, payment procedures, laws, trade agreements, logistics, etc., in step 5020 and stores the results in a dynamic data or transactional folder uniquely associated with the client request in step 5030. Also, ergopro 200 transmits the results or the dynamic transaction folder to the client 120 in step 5030 and stores the results in the system database 300, which categorizes and organizes the information for automatic updating and syndication to optimize future request for the same or similar information in step 5050. The stored data may become stale over time or changed by the data owner (i.e., information was obtained from UN and UN has now changed the data), which renders the stored data useless. Accordingly, instead of refreshing the data on demand, the system automatically updates the data when the underlying data is changed by the data provider or owner. However, if ergopro 200 is unable to process or respond to the request, then ergopro 200 generates an error message in step 5040. For example, the requested information may be currently unavailable from the system database 300.

While the present invention has been particularly described with respect to the illustrated embodiment, it will be appreciated that various alterations, modifications and adaptations may be made based on the present disclosure, and are intended to be within the scope of the present invention. It is intended that the appended claims be interpreted as including the embodiment discussed above, those various alternatives, which have been described and all equivalents thereto.

What is claimed:

1. The method of claim 4, further comprising the steps of:
building a new functional template if said international business transaction does not relate to any of said plurality of existing functional templates; and
storing said new functional template in said database.

2. The method of claim 4, further comprising the step of generating a user profile for said party if it is determined that a user profile does not exists for said party.

3. The method of claim 8, wherein the step of retrieving comprises the step of retrieving at least one of the following information from said database: export procedures, tax instructions, bill of lading, bill presentment, calculations, payment procedures, laws, trade agreements, and logistics.

4. A method for processing and syndicating international business transactions over a communications network, comprising the steps of:
receiving a transactional request from a party over said communications network, said transactional request comprising terms of an international business transaction;
generating one or more functional templates from a plurality of existing functional templates stored in a database in accordance with the terms of said international business transaction and a user profile of said party;
presenting transactional data of said international business transaction in accordance with said one or more functional templates to said party for verification, said transactional data comprising client and business data; and
executing said international business transaction after said transactional data has been verified by said party.

5. The method of claim 4, wherein the step of generating comprises the steps of:
collecting said transactional data in accordance with the terms of said international business transaction and said user profile; and
converting said transactional data into an unified or proprietary format.

6. The method of claim 5, wherein the step of collecting comprises the steps of collecting client data comprising at least one of the following: legal information, trade agreements, client contractual agreements, permitted transactions, countries and transaction types.

7. The method of claim 4, further comprising the steps of storing said transactional data in said database and retrieving said user profile from said database.

8. The method of claim 4, wherein the step of generating comprises the step of retrieving at least one of the following from said database based on said one or more functional templates and said user profile: a form, document, regulation, treaty, agreement and information.

9. The method of claim 4, further comprising the step of updating information stored in said databases from an external system or the Internet over said communications network.

10. A computer readable medium comprising code for processing and syndicating international business transactions over a communications network, said code comprising instructions for:
receiving a transactional request from a party over said communications network, said transactional request comprising terms of an international business transaction;
generating one or more functional templates from a plurality of existing functional templates stored in a database in accordance with the terms of said international business transaction and a user profile of said party;
presenting transactional data of said international business transaction in accordance with said one or more functional templates to said party for verification, said transactional data comprising client and business data; and
executing said international business transaction after said transactional data has been verified by said party.

11. The computer readable medium of claim 10, wherein said code further comprises instructions for:
collecting said transactional data in accordance with the terms of said international business transaction and said user profile; and
converting said transactional data into an unified or proprietary format.

12. The computer readable medium of claim 11, wherein the step of collecting comprises the steps of collecting client data comprising at least one of the following: legal information, trade agreements, client contractual agreements, permitted transactions, countries and transaction types.

13. The computer readable medium of claim 10, wherein said code further comprises instructions for:
building a new functional template if said international business transaction does not relate to any of said plurality of existing functional templates; and
storing said new functional template in said database.

14. The computer readable medium of claim 10, wherein said code further comprises instructions for retrieving at least one of the following from said database based on said one or more functional templates and said user profile: a form, document, regulation, treaty, agreement and information.

15. The computer readable medium of claim 14, wherein said code further comprises instructions for retrieving at least one of the following information from said database: export procedures, tax instructions, bill of lading, bill presentment, calculations, payment procedures, laws, trade agreements, and logistics.

16. A system for processing and syndicating international business transactions over a communications network, said code comprising instructions for:
an input module for receiving a transactional request from a party over said communications network, said transactional request comprising terms of an international business transaction;
a database for storing a plurality of existing functional templates and user profiles;
a processing module for generating one or more functional templates from said plurality of existing functional templates in accordance with the terms of said international business transaction and a user profile of said party; and
a terminal for presenting transactional data of said international business transaction in accordance with said one or more functional templates to said party for verification, said transactional data comprising client and business data; and
wherein said processing module is operable to execute said international business transaction after said transactional data has been verified by said party.

17. The system of claim 16, wherein said processing module is operable to collect said transactional data in accordance with the terms of said international business transaction and said user profile; collect the client data comprising at least one of the following: legal information, trade agreements, client contractual agreements, permitted transactions, countries and transaction types; and convert said transactional data into an unified or proprietary format.

18. The system of claim 16, wherein said processing module is operable to build a new functional template if said international business transaction does not relate to any of said plurality of existing functional templates; and wherein said database is operable to store said new functional template.

19. The system of claim 16, wherein said processing module is operable to retrieve at least one of the following from said database based on said one or more functional templates and said user profile: a form, document, regulation, treaty, agreement and information said database.

20. The system of claim 19, wherein said processing module is operable to retrieve at least one of the following information from said database: export procedures, tax instructions, bill of lading, bill presentment, calculations, payment procedures, laws, trade agreements, and logistics.
